(19) United States
(12) Patent Application Publication
(10) Pub. No.: US 2026/0262119 A1
(43) Pub. Date: Sep. 3, 2026

(54) BALANCING TAIL TIME LATENCY

(71) Applicant: NOKIA TECHNOLOGIES OY, Espoo (FI)

(72) Inventors: Behnam DEZFOULI, San Jose, CA (US); Claude ROBERTSON, New York, NY (US); Klaus Franz DOPPLER, Albany, CA (US); Salvatore TALARICO, Sunnyvale, CA (US); Kerstin JOHNSSON, Palo Alto, CA (US); Prabodh VARSHNEY, Irving, TX (US)

(21) Appl. No.: 19/067,455

(22) Filed: Feb. 28, 2025

(51) Int. Cl. H04W 76/15

(52) U.S. Cl. CPC H04W 76/15

(57) ABSTRACT

An apparatus, method, and computer program product are provided for determining whether to transmit a response-soliciting frame or a non-response-soliciting frame based at least in part on one or more link and transmission parameters associated with an access point, AP; and transmitting the response-soliciting frame or the non-response-soliciting frame. Additionally, an apparatus, method, and computer program product are provided for determining one or more link and transmission parameters associated with one or more stations, STAs, the one or more link and transmission parameters associated with determining whether to transmit a response-soliciting frame or a non-response-soliciting frame; and signaling the one or more link and transmission parameters to the one or more STAs.

### TECHNOLOGICAL FIELD

Various example embodiments relate generally to wireless communication networks such as Wi-Fi in which latency sensitive applications may be employed.

### BACKGROUND

Some applications of wireless technology rely on low-latency. For example, a communications system may rely on providing low latency for stations (STAs) running latency-sensitive applications, such as virtual reality, mixed reality, augmented reality, or the like.

### BRIEF SUMMARY

An apparatus, method and computer program product are provided for transmitting response-soliciting frames and non-response-soliciting frames.

According to an aspect of the present disclosure, there is provided an apparatus including at least one processor and at least one memory storing instructions that, when executed by the at least one processor, cause the apparatus to perform at least determining whether to transmit a response-soliciting frame or a non-response-soliciting frame based at least in part on one or more link and transmission parameters associated with an access point, AP, and transmitting the response-soliciting frame or the non-response-soliciting frame.

The apparatus of some embodiments is also caused to perform receiving group parameter information and determining a group the apparatus is assigned to based at least in part on the group parameter information. In this embodiment, determining whether to transmit the response-soliciting frame or the non-response-soliciting frame is further based at least in part on the group the apparatus is assigned to. The apparatus of some embodiments is also caused to perform receiving group assignment information that assigns the apparatus to a group. In this embodiment, determining whether to transmit the response-soliciting frame or the non-response-soliciting frame is further based at least in part on the group the apparatus is assigned to.

According to some embodiments, the one or more link and transmission parameters are associated with one or more link and transmission parameters of the group the apparatus is assigned to. In some embodiments, at least one of the one or more link and transmission parameters are associated with transmissions between the AP and one or more other station (STAs). In some embodiments, at least one of the one or more link and transmission parameters are associated with transmissions between the AP and the apparatus. In some embodiments, the one or more link and transmission parameters include at least one signal quality indicator, the at least one signal quality indicator including at least one received signal strength indicator, RSSI. In some embodiments, the one or more link and transmission parameters include at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame.

According to some embodiments, transmitting the non-response-soliciting frame enables the apparatus to compete for channel access sooner as compared to transmitting the response-soliciting frame. In some embodiments, transmitting the response-soliciting frame or the non-response-soliciting frame is during an enhanced distributed channel access, EDCA, period. In some embodiments, at least one of the one or more link and transmission parameters are received from the AP. In some embodiments, the response-soliciting frame includes a request to send, RTS, frame or data frame; or the non-response-soliciting frame includes a clear to send, CTS, -to-self frame, or RTS-to-self frame, or a non-ack-soliciting data frame. In some embodiments, the apparatus is a non-AP station.

According to another aspect of the present disclosure, there is provided a method including determining whether to transmit a response-soliciting frame or a non-response-soliciting frame based at least in part on one or more link and transmission parameters associated with an access point, AP, and transmitting the response-soliciting frame or the non-response-soliciting frame.

The method of some embodiments further includes receiving group parameter information and determining a group an apparatus is assigned to based at least in part on the group parameter information. In this embodiment, determining whether to transmit the response-soliciting frame or the non-response-soliciting frame is further based at least in part on the group the apparatus is assigned to. The method of some embodiments further includes receiving group assignment information that assigns the apparatus to a group. In this embodiment, determining whether to transmit the response-soliciting frame or the non-response-soliciting frame is further based at least in part on the group the apparatus is assigned to.

According to some embodiments, the one or more link and transmission parameters are associated with one or more link and transmission parameters of the group the apparatus is assigned to. In some embodiments, at least one of the one or more link and transmission parameters are associated with transmissions between the AP and one or more other station (STAs). In some embodiments, at least one of the one or more link and transmission parameters are associated with transmissions between the AP and the apparatus. In some embodiments, the one or more link and transmission parameters include at least one signal quality indicator, the at least one signal quality indicator including at least one received signal strength indicator, RSSI. In some embodiments, the one or more link and transmission parameters include at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame.

According to some embodiments, transmitting the non-response-soliciting frame enables the apparatus to compete for channel access sooner as compared to transmitting the response-soliciting frame. In some embodiments, transmitting the response-soliciting frame or the non-response-soliciting frame is during an enhanced distributed channel access, EDCA, period. In some embodiments, at least one of the one or more link and transmission parameters are received from the AP. In some embodiments, the response-soliciting frame includes a request to send, RTS, frame or data frame; or the non-response-soliciting frame includes a clear to send, CTS, -to-self frame, or RTS-to-self frame, or a non-ack-soliciting data frame. In some embodiments, the apparatus is a non-AP station.

According to another aspect of the present disclosure, there is provided a computer program product, including at least one non-transitory computer-readable storage medium having computer-executable program code portions stored therein with the computer-executable program code portions comprising program code instructions configured to determine whether to transmit a response-soliciting frame or a non-response-soliciting frame based at least in part on one or more link and transmission parameters associated with an access point, AP, and transmit the response-soliciting frame or the non-response-soliciting frame.

According to some embodiments, the computer-executable program code portions include program code instructions configured to receive group parameter information and determining a group an apparatus is assigned to based at least in part on the group parameter information. In this embodiment, determining whether to transmit the response-soliciting frame or the non-response-soliciting frame is further based at least in part on the group the apparatus is assigned to. According to some embodiments, the computer-executable program code portions include program code instructions configured to receive group assignment information that assigns the apparatus to a group. In this embodiment, determining whether to transmit the response-soliciting frame or the non-response-soliciting frame is further based at least in part on the group the apparatus is assigned to.

According to some embodiments, the one or more link and transmission parameters are associated with one or more link and transmission parameters of the group the apparatus is assigned to. In some embodiments, at least one of the one or more link and transmission parameters are associated with transmissions between the AP and one or more other station (STAs). In some embodiments, at least one of the one or more link and transmission parameters are associated with transmissions between the AP and the apparatus. In some embodiments, the one or more link and transmission parameters include at least one signal quality indicator, the at least one signal quality indicator including at least one received signal strength indicator, RSSI. In some embodiments, the one or more link and transmission parameters include at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame.

According to some embodiments, transmitting the non-response-soliciting frame enables the apparatus to compete for channel access sooner as compared to transmitting the response-soliciting frame. In some embodiments, transmitting the response-soliciting frame or the non-response-soliciting frame is during an enhanced distributed channel access, EDCA, period. In some embodiments, at least one of the one or more link and transmission parameters are received from the AP. In some embodiments, the response-soliciting frame includes a request to send, RTS, frame or data frame; or the non-response-soliciting frame includes a clear to send, CTS, -to-self frame, or RTS-to-self frame, or a non-ack-soliciting data frame. In some embodiments, the apparatus is a non-AP station.

According to another aspect of the present disclosure, there is provided an apparatus including means for determining whether to transmit a response-soliciting frame or a non-response-soliciting frame based at least in part on one or more link and transmission parameters associated with an access point, AP, and transmitting the response-soliciting frame or the non-response-soliciting frame.

The apparatus of some embodiments also includes means for receiving group parameter information and determining a group the apparatus is assigned to based at least in part on the group parameter information. In this embodiment, determining whether to transmit the response-soliciting frame or the non-response-soliciting frame is further based at least in part on the group the apparatus is assigned to. The apparatus of some embodiments also includes means for receiving group assignment information that assigns the apparatus to a group. In this embodiment, determining whether to transmit the response-soliciting frame or the non-response-soliciting frame is further based at least in part on the group the apparatus is assigned to.

According to some embodiments, the one or more link and transmission parameters are associated with one or more link and transmission parameters of the group the apparatus is assigned to. In some embodiments, at least one of the one or more link and transmission parameters are associated with transmissions between the AP and one or more other station (STAs). In some embodiments, at least one of the one or more link and transmission parameters are associated with transmissions between the AP and the apparatus. In some embodiments, the one or more link and transmission parameters include at least one signal quality indicator, the at least one signal quality indicator including at least one received signal strength indicator, RSSI. In some embodiments, the one or more link and transmission parameters include at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame.

According to some embodiments, transmitting the non-response-soliciting frame enables the apparatus to compete for channel access sooner as compared to transmitting the response-soliciting frame. In some embodiments, transmitting the response-soliciting frame or the non-response-soliciting frame is during an enhanced distributed channel access, EDCA, period. In some embodiments, at least one of the one or more link and transmission parameters are received from the AP. In some embodiments, the response-soliciting frame includes a request to send, RTS, frame or data frame; or the non-response-soliciting frame includes a clear to send, CTS, -to-self frame, or RTS-to-self frame, or a non-ack-soliciting data frame. In some embodiments, the apparatus is a non-AP station.

According to another aspect of the present disclosure, there is provided an apparatus including at least one processor and at least one memory storing instructions that, when executed by the at least one processor, cause the apparatus to perform at least exchanging one or more link and transmission parameters with at least one station, STA. The one or more link and transmission parameters are associated with determining whether to transmit a response-soliciting-frame or a non-response-soliciting frame. The apparatus is also caused to perform receiving the response soliciting frame or the non-response-soliciting frame from the at least one station, STA.

According to another aspect of the present disclosure, there is provided a method including exchanging one or more link and transmission parameters with at least one station, STA. The one or more link and transmission parameters are associated with determining whether to transmit a response-soliciting-frame or a non-response-soliciting frame. The method further includes receiving the response soliciting frame or the non-response-soliciting frame from the at least one station, STA.

According to another aspect of the present disclosure, there is provided a computer program product, including at least one non-transitory computer-readable storage medium having computer-executable program code portions stored therein with the computer-executable program code portions comprising program code instructions configured to exchange one or more link and transmission parameters with at least one station, STA. The one or more link and transmission parameters are associated with determining whether to transmit a response-soliciting-frame or a non-response-soliciting frame. The computer-executable program code portions include program code instructions configured to receive the response soliciting frame or the non-response-soliciting frame from the at least one station, STA.

According to another aspect of the present disclosure, there is provided an apparatus including means for exchanging one or more link and transmission parameters with at least one station, STA. The one or more link and transmission parameters are associated with determining whether to transmit a response-soliciting-frame or a non-response-soliciting frame. The apparatus also includes means for receiving the response soliciting frame or the non-response-soliciting frame from the at least one station, STA.

According to another aspect of the present disclosure, there is provided an apparatus including at least one processor and at least one memory storing instructions that, when executed by the at least one processor, cause the apparatus to perform at least determining one or more link and transmission parameters associated with one or more stations, STAs. The one or more link and transmission parameters are associated with determining whether to transmit a response-soliciting frame or a non-response-soliciting frame. The apparatus is also caused to perform signaling the one or more link and transmission parameters to the one or more STAs.

According to some embodiments, the one or more link and transmission parameters are used by the one or more STAs to determine whether to transmit the response-soliciting frame or the non-response-soliciting frame. The apparatus of some embodiments is also caused to perform assigning at least one of the one or more STAs to a group based on the one or more link and transmission parameters. In this embodiment, the group is associated with one or more link and transmission parameters used to determine whether to transmit the response-soliciting frame or the non-response-soliciting frame and signaling the one or more link and transmission parameters includes indicating the group. The apparatus of some embodiments is also caused to perform determining group parameter information by determining one or more link and transmission parameters associated with each group of one or more groups. In this embodiment, the one or more link and transmission parameters of each group are usable to determine whether to transmit a response-soliciting frame or a non-response-soliciting frame and signaling the one or more link and transmission parameters includes indicating the group parameter information.

According to some embodiments, the one or more link and transmission parameters include at least one signal quality indicator and the at least one signal quality indicator includes at least one received signal strength indicator, RSSI. In some embodiments, the one or more link and transmission parameters includes at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame. In some embodiments, the one or more link and transmission parameters are associated with transmissions between the apparatus and the one or more STAs.

The apparatus of some embodiments is also caused to perform receiving a non-response-soliciting frame from a first STA of the one or more STAs; and receiving a response-soliciting frame from a second STA of the one or more STAs at an overlapping time as the non-response-soliciting frame. In this embodiment, the non-response-soliciting frame enables the first STA to compete for channel access sooner as compared to the second STA.

According to another aspect of the present disclosure, there is provided a method including determining one or more link and transmission parameters associated with one or more stations, STAs. The one or more link and transmission parameters are associated with determining whether to transmit a response-soliciting frame or a non-response-soliciting frame. The method further includes signaling the one or more link and transmission parameters to the one or more STAs.

According to some embodiments, the one or more link and transmission parameters are used by the one or more STAs to determine whether to transmit the response-soliciting frame or the non-response-soliciting frame. The method of some embodiments further includes assigning at least one of the one or more STAs to a group based on the one or more link and transmission parameters. In this embodiment, the group is associated with one or more link and transmission parameters used to determine whether to transmit the response-soliciting frame or the non-response-soliciting frame and signaling the one or more link and transmission parameters includes indicating the group. The method of some embodiments further includes determining group parameter information by determining one or more link and transmission parameters associated with each group of one or more groups. In this embodiment, the one or more link and transmission parameters of each group are usable to determine whether to transmit a response-soliciting frame or a non-response-soliciting frame and signaling the one or more link and transmission parameters includes indicating the group parameter information.

According to some embodiments, the one or more link and transmission parameters include at least one signal quality indicator and the at least one signal quality indicator includes at least one received signal strength indicator, RSSI. In some embodiments, the one or more link and transmission parameters includes at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame. In some embodiments, the one or more link and transmission parameters are associated with transmissions between an apparatus and the one or more STAs.

The method of some embodiments further includes receiving a non-response-soliciting frame from a first STA of the one or more STAs; and receiving a response-soliciting frame from a second STA of the one or more STAs at an overlapping time as the non-response-soliciting frame. In this embodiment, the non-response-soliciting frame enables the first STA to compete for channel access sooner as compared to the second STA.

According to another aspect of the present disclosure, there is provided a computer program product, including at least one non-transitory computer-readable storage medium having computer-executable program code portions stored therein with the computer-executable program code portions comprising program code instructions configured to determine one or more link and transmission parameters associated with one or more stations, STAs. The one or more link and transmission parameters are associated with determining whether to transmit a response-soliciting frame or a non-response-soliciting frame. The computer-executable program code portions include program code instructions configured to signal the one or more link and transmission parameters to the one or more STAs.

According to some embodiments, the one or more link and transmission parameters are used by the one or more STAs to determine whether to transmit the response-soliciting frame or the non-response-soliciting frame. According to some embodiments, the computer-executable program code portions include program code instructions configured to assign at least one of the one or more STAs to a group based on the one or more link and transmission parameters. In this embodiment, the group is associated with one or more link and transmission parameters used to determine whether to transmit the response-soliciting frame or the non-response-soliciting frame and signaling the one or more link and transmission parameters includes indicating the group. According to some embodiments, the computer-executable program code portions include program code instructions configured to determine group parameter information by determining one or more link and transmission parameters associated with each group of one or more groups. In this embodiment, the one or more link and transmission parameters of each group are usable to determine whether to transmit a response-soliciting frame or a non-response-soliciting frame and signaling the one or more link and transmission parameters includes indicating the group parameter information.

According to some embodiments, the one or more link and transmission parameters include at least one signal quality indicator and the at least one signal quality indicator includes at least one received signal strength indicator, RSSI. In some embodiments, the one or more link and transmission parameters includes at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame. In some embodiments, the one or more link and transmission parameters are associated with transmissions between an apparatus and the one or more STAs.

According to some embodiments, the computer-executable program code portions include program code instructions configured to receive a non-response-soliciting frame from a first STA of the one or more STAs; and receive a response-soliciting frame from a second STA of the one or more STAs at an overlapping time as the non-response-soliciting frame. In this embodiment, the non-response-soliciting frame enables the first STA to compete for channel access sooner as compared to the second STA.

According to another aspect of the present disclosure, there is provided an apparatus including means for determining one or more link and transmission parameters associated with one or more stations, STAs. The one or more link and transmission parameters are associated with determining whether to transmit a response-soliciting frame or a non-response-soliciting frame. The apparatus also includes means for signaling the one or more link and transmission parameters to the one or more STAs.

According to some embodiments, the one or more link and transmission parameters are used by the one or more STAs to determine whether to transmit the response-soliciting frame or the non-response-soliciting frame. The apparatus of some embodiments also includes means for assigning at least one of the one or more STAs to a group based on the one or more link and transmission parameters. In this embodiment, the group is associated with one or more link and transmission parameters used to determine whether to transmit the response-soliciting frame or the non-response-soliciting frame and signaling the one or more link and transmission parameters includes indicating the group. The apparatus of some embodiments also includes means for determining group parameter information by determining one or more link and transmission parameters associated with each group of one or more groups. In this embodiment, the one or more link and transmission parameters of each group are usable to determine whether to transmit a response-soliciting frame or a non-response-soliciting frame and signaling the one or more link and transmission parameters includes indicating the group parameter information.

According to some embodiments, the one or more link and transmission parameters include at least one signal quality indicator and the at least one signal quality indicator includes at least one received signal strength indicator, RSSI. In some embodiments, the one or more link and transmission parameters includes at least one switching algorithm. In some embodiments, the at least one switching algorithm includes a probability used for determining whether to transmit the response-soliciting frame or the non-response-soliciting frame. In some embodiments, the one or more link and transmission parameters include at least one failed transmissions threshold indicative of a number of failed transmissions necessary to be eligible to transmit the non-response-soliciting frame. In some embodiments, the one or more link and transmission parameters are associated with transmissions between the apparatus and the one or more STAs.

The apparatus of some embodiments also includes means for receiving a non-response-soliciting frame from a first STA of the one or more STAs; and receiving a response-soliciting frame from a second STA of the one or more STAs at an overlapping time as the non-response-soliciting frame. In this embodiment, the non-response-soliciting frame enables the first STA to compete for channel access sooner as compared to the second STA.

According to another aspect of the present disclosure, there is provided an apparatus including at least one processor and at least one memory storing instructions that, when executed by the at least one processor, cause the apparatus to perform at least determining whether to transmit a response-soliciting frame or a non-response-soliciting frame based at least in part on one or more link and transmission parameters; and transmitting the response-soliciting frame or the non-response-soliciting frame.

According to some embodiments, the apparatus is an access point, AP. According to some embodiments, transmitting the response-soliciting frame or the non-response-soliciting frame includes transmitting the response-soliciting frame or the non-response-soliciting frame to least one of an AP or a non-AP station, STA.

According to another aspect of the present disclosure, there is provided a method including determining whether to transmit a response-soliciting frame or a non-response-soliciting frame based at least in part on one or more link and transmission parameters; and transmitting the response-soliciting frame or the non-response-soliciting frame.

According to some embodiments, various operations of the method are performed by an access point, AP. According to some embodiments, transmitting the response-soliciting frame or the non-response-soliciting frame includes transmitting the response-soliciting frame or the non-response-soliciting frame to least one of an AP or a non-AP station, STA.

According to another aspect of the present disclosure, there is provided a computer program product, including at least one non-transitory computer-readable storage medium having computer-executable program code portions stored therein with the computer-executable program code portions comprising program code instructions configured to determine whether to transmit a response-soliciting frame or a non-response-soliciting frame based at least in part on one or more link and transmission parameters; and transmit the response-soliciting frame or the non-response-soliciting frame.

According to some embodiments, various operations of the computer program product are performed by an access point, AP. According to some embodiments, transmitting the response-soliciting frame or the non-response-soliciting frame includes transmitting the response-soliciting frame or the non-response-soliciting frame to least one of an AP or a non-AP station, STA.

According to another aspect of the present disclosure, there is provided an apparatus including means for determining whether to transmit a response-soliciting frame or a non-response-soliciting frame based at least in part on one or more link and transmission parameters; and transmitting the response-soliciting frame or the non-response-soliciting frame.

According to some embodiments, the apparatus is an access point, AP. According to some embodiments, transmitting the response-soliciting frame or the non-response-soliciting frame includes transmitting the response-soliciting frame or the non-response-soliciting frame to least one of an AP or a non-AP station, STA.

According to another aspect of the present disclosure, there is provided an apparatus including at least one processor and at least one memory storing instructions that, when executed by the at least one processor, cause the apparatus to perform at least receiving signaling for at least one or more link and transmission parameters associated with determining whether to transmit a response-soliciting frame or a non-response-soliciting frame; and transmitting the response-soliciting frame or the non-response-soliciting frame based at least in part on the signaling.

According to another aspect of the present disclosure, there is provided a method including receiving signaling for at least one or more link and transmission parameters associated with determining whether to transmit a response-soliciting frame or a non-response-soliciting frame; and transmitting the response-soliciting frame or the non-response-soliciting frame based at least in part on the signaling.

According to another aspect of the present disclosure, there is provided a computer program product, including at least one non-transitory computer-readable storage medium having computer-executable program code portions stored therein with the computer-executable program code portions comprising program code instructions configured to receive signaling for at least one or more link and transmission parameters associated with determining whether to transmit a response-soliciting frame or a non-response-soliciting frame; and transmit the response-soliciting frame or the non-response-soliciting frame based at least in part on the signaling.

According to another aspect of the present disclosure, there is provided an apparatus including means for receiving signaling for at least one or more link and transmission parameters associated with determining whether to transmit a response-soliciting frame or a non-response-soliciting frame; and transmitting the response-soliciting frame or the non-response-soliciting frame based at least in part on the signaling.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a diagram of an example communication system in accordance with at least an example embodiment;

FIG. 2 illustrates an example operation of the HiP EDCA period mechanism;

FIG. 3 illustrates an example of tail time latency increase for STAs with lower received signal quality at the AP;

FIG. 4 illustrates an example of transmitting a non-response-soliciting frame in accordance with some example embodiments described herein;

FIG. 5 illustrates an example of link and transmission parameters in accordance with some example embodiments described herein;

FIG. 6 illustrates an example of link and transmission parameters in accordance with some example embodiments described herein;

FIG. 7 illustrates the operations performed, such as by the apparatus of FIG. 12, in accordance with at least an example embodiment;

FIG. 8 illustrates the operations performed, such as by the apparatus of FIG. 12, in accordance with at least an example embodiment;

FIG. 9 illustrates the operations performed, such as by the apparatus of FIG. 12, in accordance with at least an example embodiment;

FIG. 10 illustrates the operations performed, such as by the apparatus of FIG. 12, in accordance with at least an example embodiment;

FIG. 11 illustrates the operations performed, such as by the apparatus of FIG. 12, in accordance with at least an example embodiment; and

FIG. 12 is a block diagram of an apparatus that may be specifically configured in accordance with an example embodiment of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Certain embodiments described may be implemented in a communications system (e.g., a communication network), such as any of the following radio access technologies (RATs): wireless fidelity (Wi-Fi), BLUETOOTH, Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunications system (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future radio access technology (RAT) such as 6G. Moreover, communication within the communication network may utilize any suitable wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiplexing (OFDM), and/or Discrete Fourier Transform spread OFDM (DFT-s-OFDM).

The term “terminal device” refers to any end device that may be capable of wireless communication. By way of example, a terminal device may be referred to as a communication device, user equipment (UE), a Subscriber Station (SS), a Mobile Station (MS). The terminal device may include a mobile phone, a cellular phone, a smart phone, voice over IP (VOIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, universal serial bus (USB) USB dongles, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

The term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving respectively via a wireless propagation channel on radio resources.

In some examples, a communications system may be deployed in a wireless local area network (WLAN), such as a Wi-Fi network. That is, in some examples, a communications system may be an example of a WLAN system. The WLAN system may support wireless communications between one or more communications devices in accordance with one or more Wi-Fi protocols, such as protocols based on institute of electrical and electronics engineers (IEEE) 802.11 standards and/or related drafts, such as 802.11-2020, 802.11ac, 802.11ax, 802.11be, 802.11bn, and/or others.

In some examples, Wi-Fi communications may occur via one or more radio frequency bands, such as 2.4 gigahertz (GHz), 3.6 GHz, 5 GHz, 6 GHz, 60 GHz, and/or the like. In some such examples, each radio frequency band may support one or more channels (e.g., 20 megahertz (MHz) channels) over which data may be communicated. In some examples, multiple devices may use multiple channels to communicate over the WLAN simultaneously.

A WLAN system may include one or more communications devices, such as an access point (AP) and/or a station (STA), which is also referred to herein as a non-AP STA. For example, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID) or a basic service set identifier (BSSID).

In some examples, an AP of a WLAN system includes at least one distribution system access function configured to facilitate data communication beyond the AP. Additionally, or alternatively, STAs may be configured to be end devices, which rely on association with an AP to communicate with devices other than the AP. An AP may be configured to connect to a wired local area network (LAN) (e.g., via Ethernet). The AP may allow one or more client devices (e.g., STAs) to access wireless connections via WLAN. The client devices may also be referred to as “WLAN clients”. WLAN clients may comprise various devices and/or types of devices, including laptops, tablets, cell phones, and/or other devices.

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity, which may be configured to act as a network manager. In some examples, the network manager is a cloud-based entity, which may reside either in a private cloud or in a public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more STAs (also referred to as clients or client devices) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDU, wherein a payload of a PDU may comprise user data, control data, management data, and/or other data. In some examples, a WLAN system may implement one or more security protocols to protect the confidentiality, integrity, and availability of Wi-Fi communications.

In some examples, a WLAN system may support transmission opportunities (TXOPs) to increase throughput, such as for high priority data, by providing contention-free channel access for a period of time. A TXOP may be available in a quality of service (QOS) mode as part of Enhanced Distributed Channel Access (EDCA), and/or may be a limited time period of contention-free channel access available to the channel-owning station (e.g., the TXOP holder). During such a period a TXOP holder, which may be a STA or an AP, may send multiple frames that satisfy criteria, which may have been determined for the use of TXOP. In some examples, the criteria may allow transmission of frames belonging to an access category (AC) other than the AC for which the TXOP has been obtained. In some examples, a TXOP may increase throughput and/or reduce delay of QoS data frames by eliminating contention periods between transmissions. In some examples, a TXOP may be used in combination with frame aggregation and block acknowledgement to further increase throughput.

In some examples, access categories have different channel access parameters, such as Arbitration Interframe Spacing (AIFS), duration, contention window size, and TXOP limit. In some examples, values of these parameters may be set in a manner that increases a likelihood of higher priority packets being prioritized over lower priority packets. For example, the values of the parameters may be set that a STA (typically) waits for a shorter duration before sending the higher priority packets compared to a duration that the STA may wait before sending the lower priority packets. Additionally, or alternatively, the values of the parameters may be set so that the contention window for higher priority packets is smaller than that of lower priority packets and/or so that multiple packets may be sent in a TXOP. In some examples, a TXOP holder, which may be either a STA or an AP, may send frames to multiple recipients during a TXOP. In addition to QoS data frames, other frames may be exchanged during the TXOP, such as an acknowledgement (ACK), BlockAckReq/BlockAck frames, and/or other control and management frames.

In some examples, a WLAN system uses multi-link operation (MLO) to improve data transmission (e.g., via using multiple frequency bands for transmissions). In some examples, MLO further comprises various features, including simultaneous transmit and receive (STR), multi-channel multi-radio (MCMR), enhanced multi-AP roaming (E-MAR), non-simultaneous transmit and receive (NSTR), multi-link multi-radio (MLMR), and/or other features.

An AP that supports MLO may be referred to as an AP multi-link device (MLD). An MLO-capable client, for example, such as a STA, may be referred to as a non-AP MLD. Such a client device may have two or more STAs with which it may establish links to an AP MLD. A connection between a STA and AP may represent a link between an AP MLD and a non-AP MLD. In some examples, APs which do not support MLO may be multi-band APs which have two or more APs operating in different bands and/or channels. An AP may operate in one or more bands and/or channels and a client device may connect to the AP via one or more of the bands and/or channels. For example, a client device may associate with the AP in one of the channels. An AP MLD may operate as a multi-band AP, while providing means for a multi-link (ML) capable client (non-AP MLD) to simultaneously use two or more of its radios and/or APs for communication with a single association. An AP MLD may be an MLMR, which is configured to communicate simultaneously with its APs with associated non-AP MLDs. Non-AP MLDs may have constraints (e.g., NSTR), which may indicate that simultaneous communication over established links is not possible. Therefore, in some such instances, a non-AP MLD may associate to an AP MLD. Accordingly, the non-AP MLD may be associated over two or more bands and/or channels and may communicate with the APs affiliated to the AP MLD over the established links.

WLAN devices configured with STR may be configured to allow simultaneous transmission and/or reception via different respective frequency bands, which may reduce latency. WLAN devices configured with MCMR may be configured to allow data transmission via two or more radios and/or channels, which may increase efficiency, reduce congestion, and/or increase network speeds. WLAN devices configured with enhanced multilink single-radio (EMLSR) may be configured to allow client devices to switch between multiple respective APs while maintaining their connections, which may allow more consistent connectivity. WLAN devices configured with NSTR may be configured to allow client devices to non-simultaneous transmission and/or reception via different respective frequency bands, which may reduce latency (particularly in comparison with single-link operation). WLAN devices configured with MLMR may be configured to allow different respective radios and/or channels to be used for managing respective links, which may reduce interference and/or improve network performance.

A WLAN system may be configured with various types of service sets, for example, such as basic service set (BSS) and/or an extended service set (ESS). A BSS may be comprised of an AP and one or more client devices (e.g., STAs) associated with the AP. The one or more client devices may have one or more common physical layer (PHY) medium access characteristics (e.g., radio frequency, modulation scheme, security settings, and/or the like). A BSSID may define the BSS such that the one or more client devices of the BSS share the same BSSID.

In some examples, two or more BSSs may have overlapping coverage areas, and they may operate with either partially or entirely same radio frequency channels. In such examples of overlapping BSSs (OBSSs), a client device may transmit frames from the area of overlap, and one or more other client devices may sense the transmission. Responsive to sensing the transmission, the one or more other client devices may cease their own transmissions. In some examples, if the other client devices do not sense the transmission, the other client devices may become hidden terminals with respect to the client device which is transmitting.

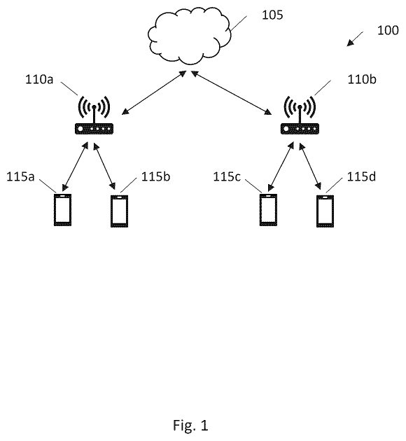

FIG. 1 illustrates an example communications system 100 to which one or more examples disclosed herein may be applied. The communications system 100 may include a cloud network 105, one or more APs (e.g., an AP 110-a, an AP 110-b), and one or more client devices, also referred to herein as STAs, connected to the one or more APs. For example, the communications system 100 may include a STA 115-a and a STA 115-b connected to the AP 110-a, as well as a STA 115-c and a STA 115-d connected to the AP 110-b. In some examples, the APs 110 may be mobile access points (mAPs) with constrained functionality. In some such examples, a configuration comprising an mAP and a STA may be implemented as part of a peer-to-peer connection, for example, as in Wi-Fi Direct or Wi-Fi Aware. In some examples, a device may simultaneously operate as a STA and as an AP. One such an example case is in a multi-AP or mesh network, which includes two or more devices that may act as APs and use Wi-Fi for the wireless backhaul connectivity based on a STA-AP connection model.

In some wireless communications systems, APs may provide wireless connectivity for one or more STAs according to the Wi-Fi standards, such as those that are a subset of the IEEE 802 family of standards. For example, the MAC and PHY specifications for Wi-Fi access points are defined by IEEE 802.11 for transmitting and receiving data in frequency bands such as 2.4 GHz, 3.6 GHz, 5 GHz, 6 GHz, 60 GHz, and/or the like. APs and STAs may communicate through the transmission of frames, including data frames, management frames, and/or control frames, which may be transmitted in unicast messages, broadcast messages, or multicast messages. The 802.11 standards define an inter-frame space (IFS) as the nominal time (in microseconds (us)) that the MAC and PHY use to receive the last symbol of a frame, process the frame, and respond with the first symbol of a response frame (e.g., the earliest possible response frame).

In the example of FIG. 1, the STAs 115 may be configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, STAs, UEs, and/or other entities suitable for such usage. For example, the communications system 100 may support radio frequency sensing during IFS.

The communications system 100 may support latency-sensitive applications at Wi-Fi devices (e.g., APs, STAs). Some such applications may include for example virtual reality (VR) applications, mixed reality applications, extended reality (XR) and augmented reality (AR) applications. In some cases, reliability and non-deterministic channel access, such as for wideband transmissions, may constrain a performance of latency-sensitive applications. For example, for a wideband transmission (or channel bonding), a device may use a primary 20 MHz channel to communicate control frames and management frames and may communicate data frames by bonding a BSS primary channel (also referred to herein as a reference primary channel or, more simply, a primary channel) with one or more other available 20 MHz channels, which are referred to as secondary channels. Channel bonding was introduced to provide for transmissions over multiple contiguous 20 MHz channels. In some instances, channel bonding may support transmissions over a total bandwidth of 40 MHz, 80 MHz, 160 MHz, or 320 MHz.

In some examples, if the device assesses the BSS primary channel to be idle, the device may perform a wideband transmission across a bandwidth including the BSS primary channel or the BSS primary channel and one or multiple contiguous secondary channels (e.g., totaling 40 MHz, 80 MHz, or 160 MHz or 320 MHz). In some instances, however, an overlapping basic service set (OBSS) transmission may overlap (partially or fully) with the BSS primary channel. In some such instances, the device may determine that the BSS primary channel is busy and, as such, may defer the wideband transmission. Consequently, the secondary channels may sit idle until the BSS primary channel is available, which may lead to reduced performance, for example, for latency-sensitive applications.

A procedure (e.g., a procedure defined in IEEE 802.11ac) may enable a device, such as a STA, to adjust a transmission bandwidth of the STA per TXOP to include 20 MHz, 40 MHz, 80 MHz, or 160 MHz based on channel availability. In some examples, however, the adjustment to the transmission bandwidth may be contingent upon the resulting bandwidth being contiguous, and the primary channel was assessed to be idle. For example, the STA may adjust the transmission bandwidth of the STA per TXOP to include 20 MHz, 40 MHz, 80 MHz, or 160 MHz based on channel availability so long as the resulting bandwidth is contiguous, and the primary channel was assessed to be idle. In some cases, however, such constraint may result in a substantial amount of unused spectrum, as some non-contiguous 20 MHz channels may be available, but sit idle due to the STA being constrained to using contiguous channels.

Recently, efforts have been made to improve channel access latency in 802.11 networks, particularly for low-latency traffic. The contributions presented in IEEE 802.11-23/1065r0, IEEE 802.11-23/2126r3, IEEE 802.11-24/0467r1, and IEEE 802.11-24/0840r0 introduce the concept of High-Priority EDCA (HiP EDCA), which aims to reduce tail latency in channel access and enhance latency predictability for low-latency (LL) traffic. These contributions and the issues identified herein demonstrate that the existing EDCA mechanism seeks to provide adequate separation between traffic categories, particularly when multiple LL streams compete for the channel.

To address this problem, a mechanism has been proposed in which STAs with LL traffic can send a Defer Signal (DS) to initiate high-priority channel access. Sending DS frames allows LL STAs to contend among themselves, avoiding competition with lower-priority traffic (e.g., STAs with best-effort traffic) or LL STAs that have not sent the DS frame. The HiP EDCA mechanism presented in IEEE 802.11-24/1144r1 and IEEE 802.11-24/1918r0 utilizes a short control frame (e.g., clear-to-send (CTS) or request-to-send (RTS)) as the DS frame. A STA may send a DS frame after a certain number of failed channel access attempts. Once a STA sends a DS frame, it can compete for channel access after an Arbitration Inter-Frame Space (AIFS) following the end of the DS frame. STAs that successfully receive the DS frame use the Duration field (Duration/ID) value to update their Network Allocation Vector (NAV) before attempting channel access again. Also, STAs that receive only the PHY preamble or PHY header will set an Extended Inter-Frame Space (EIFS) before reattempting channel access. Thus, this method increases the likelihood that STAs transmitting a DS frame will win channel access, prioritizing LL traffic and improving latency performance.

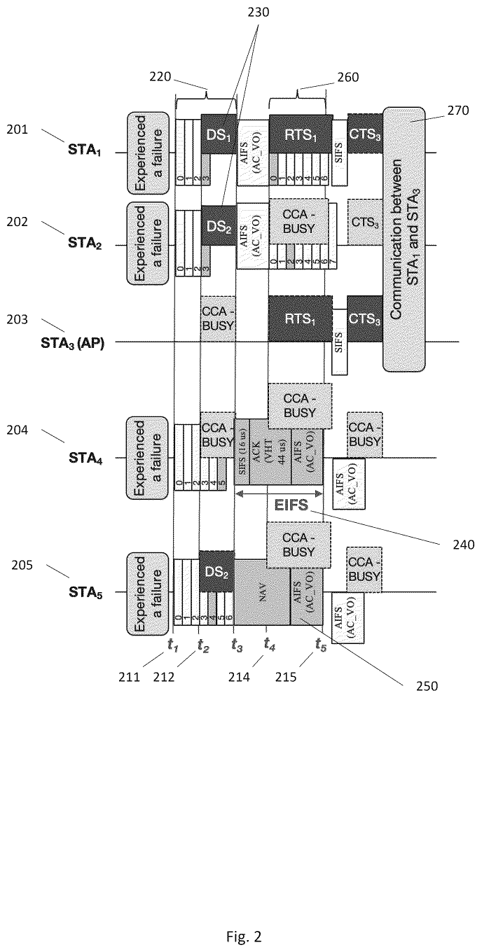

FIG. 2 illustrates an example operation of the HiP EDCA period mechanism, for example, as presented in IEEE 802.11-23/1065r0, IEEE 802.11-23/2126r3, IEEE 802.11-24/0467r1, IEEE 802.11-24/0840r0, IEEE 802.11-24/1144r1, and IEEE 802.11-24/1918r0. As shown, STA 201 (denoted as “STA₁”), STA 202 (denoted as “STA₂”), STA 204 (denoted as “STA₄”), and STA 205 (denoted as “STA₅”) need to transmit LL traffic (belonging to AC_VO) to AP 203 (denoted as “STA₃ (AP)”). As used herein, the term STA refers to a non-AP station (non-AP Sta). In this example, STA 201, STA 202, STA 204, and STA 205 are competing for channel access, as shown in the contention round 220, and these STAs have experienced a certain number of failures (e.g., an RTS transmission without any response) during contention rounds prior to time 211 (denoted as “t₁”). Therefore, STA 201, STA 202, STA 204 and STA 205 are eligible to send DS frames. STA 201 and STA 202 select earlier timeslots compared to STA 204 and STA 205. Specifically, STA 201 and STA 202 select the three timeslot (denoted by the number “3” in the contention round 220), STA 204 selects the five timeslot (denoted by the number “5” in the contention round 220) and STA 205 selects the four timeslot (denoted by the number “4” in the contention round 220). Since STA 201 and STA 202 select the same timeslot starting at time 212 (denoted as “t₂”), STA 201 and STA 202 transmit their DS frames simultaneously, as shown at 230. STA 204 only receives the PHY header of the DS frame sent by STA 202. Accordingly, STA 204 waits for the EIFS duration before reattempting channel access, as shown at 240. In contrast, STA 205 successfully receives the entire DS frame sent by STA 202. Therefore, STA 205 uses the Duration field of this DS frame to set its NAV. The duration of NAV+AIFS is set to be the same as the duration set by the EIFS process, as shown at 250. Both STA 204 and STA 205 may compete for channel access again at time 215 (denoted as “t₅”). However, STA 201 and STA 202 may compete for channel access before STA 204 and STA 205. Specifically, the earliest timeslot that STA 201 and STA 202 may select is at time 214 (denoted as “t₄”), which is AIFS[AC_VO] after the end of their DS frame transmissions.

Continuing the example of FIG. 2, STA 201 and STA 202 are competing for channel access as shown in the contention round 260. STA 201 selects the zero timeslot (denoted by the number “0” in the contention round 260) and transmits an RTS frame starting at time 214. Since STA 202 selects the two timeslot (denoted by the number “2” in the contention round 260), STA 202 cannot initiate transmission, as the channel is sensed as busy from the zero timeslot onward. AP 203 receives the RTS frame transmitted by STA 201 (denoted as “RTS₁”), responds with a CTS frame (denoted as “CTS₃”), and then STA 201 and AP 203 proceed with communication as shown at 270.

Note STA 204 and STA 205 did not interfere with the contention round 260 between STA 201 and STA 202 due to setting the EIFS and NAV, respectively. These mechanisms ensured that STA 204 and STA 205 deferred their channel access contention, allowing STA 201 and STA 202 to proceed with their contention without interference. If a STA, such as STA 204 or STA 205, does not receive at least the preamble of one of the DS frames sent by STA 201 and STA 202 shown at 230, then deferment will not be implemented (e.g., NAV or EIFS). Instead, the STA, such as STA 204 or STA 205 will compete for channel access AIFS[AC] time after sensing the channel as idle.

In an example, a set of non-AP STAs have different received signal quality (strength) at the AP. When such a set of STAs compete for channel access using EDCA, the success of STAs with lower signal quality (received at the AP) is adversely affected by the STAs with higher signal quality. Therefore, the tail time latency of communication increases for STAs whose received signal quality is lower at the AP.

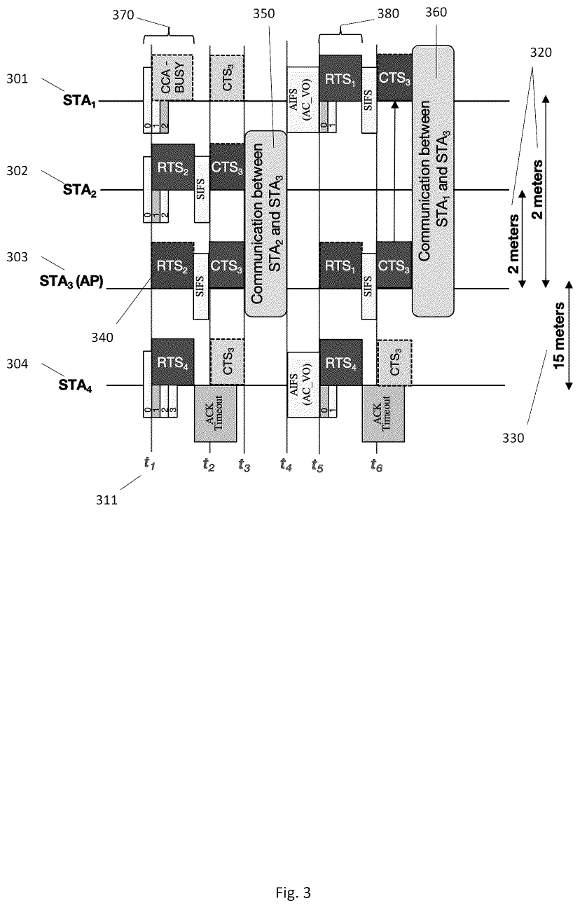

FIG. 3 illustrates an example of tail time latency increase for STAs with lower received signal quality at the AP. For example, STA 301 (denoted as “STA₁”), STA 302 (denoted as “STA₂”) and STA 304 (denoted as “STA₄”) are non-AP STAs that need to send AC_VO traffic (i.e., traffic belonging to the voice access category) to AP 303 (denoted as “STA₃ (AP)”). In this example, STA 301 and STA 302 are located 2 meters from the AP 303 as shown at 320, while STA 304 is 15 meters away from the AP 303 as shown at 330. Accordingly, the signal strength received from STA 301 and STA 302 may be relatively higher (e.g., around −45 dBm) while the signal strength received from STA 304 may be relatively lower (e.g., around −75 dBm). In this example, STA 302 and STA 304 both select the one timeslot (denoted by the number “1” in the contention round 370) and transmit RTS frames (denoted as “RTS₂” and “RTS₄” respectively) simultaneously at time 311 (denoted as “t₁”). STA 302 and STA 304 also initiate their ACK Timeout counters and wait to receive an CTS from the AP 303. Note that ACK Timeout=aSIFSTime+RxPhyStartDelay+aSlotTime, where RxPhyStartDelay is the delay in microseconds from the start of the PPDU at the receiver's antenna to the issuance of the PHY-RXSTART. indication primitive. The value of RxPhyStartDelay depends on the PHY layer used. In this example, ACK Timeout=aSIFSTime+RxPhyStartDelay+aSlotTime=16+20+9=45 μs (for OFDM/non-HT PHY).

Since STA 302 is closer to the AP 303, the AP 303 successfully receives the RTS frame sent by STA 302 (denoted as “RTS₂”), as shown at 340. When the AP 303 replies to STA 302 with a CTS frame (denoted as “CTS₃”), STA 301, STA 302, and STA 304 receive it. Upon reception of the CTS frame, STA 302 and AP 303 have completed a TXOP reservation and begin exchanging data frames as shown at 350. However, since the CTS frame received by STA 304 is not its expected response, STA 304 must wait until the TXOP ends before it may contend for the channel again.

After the TXOP expires, STA 304 waits for AIFS[AC_VO] and then competes for channel access again. During the contention round 380, both STA 301 and STA 304 select the zero timeslot (denoted by the number “0” in the contention round 380) and transmit RTS frames (denoted as “RTS₁” and “RTS₄” respectively) simultaneously. This time, the AP 303 successfully receives the RTS frame sent by STA 301 because it is closer than STA 304. Thus, STA 304 loses the contention again as STA 301 and AP 303 begin exchanging data, as shown at 360.

If the number of STAs closer to the AP 303 than STA 304 is high, STA 304 will have a much lower chance of winning channel access compared to the STAs close to the AP 303. In a more generic case, the problem presented in FIG. 3 may also apply to the case where the received signal strength from STA 301 and STA 302 is higher than that of STA 304, regardless of their distance from the AP 303. For example, STA 301, STA 302, and STA 304 may be located at the same distance from the AP 303, but STA 304 may be behind a wall, resulting in lower received signal strength. In this manner, received signal strength associated with the STAs relative to the AP cause unfair channel access, among other issues. Some example embodiments of the present disclosure address these and other issues.

Some example embodiments disclosed herein provide improved techniques for switching from transmitting response-soliciting frames to transmitting non-response-soliciting frames. For example, in some embodiments, during EDCA periods, STAs may switch from transmitting response-soliciting frames (e.g., RTS, data frames) to non-response-soliciting frames (e.g., CTS-to-self) based on certain link and transmission parameters, such as signal quality indicators (e.g., the quality or strength of the signals received by the AP from such STAs). In doing so, example embodiments provide technical improvements by providing STAs with improved probabilities for channel access and balance the tail time latency of STAs. In various embodiments, a STA transmitting a non-response-soliciting frame can compete for channel access relatively sooner than STAs transmitting response-soliciting frames. In some embodiments, a STA transmitting a non-response-soliciting frame may compete for channel access one AIFS[AC] after the end of the frame, where AC refers to the Access Category of the traffic of the STA that transmitted the non-response-soliciting frame.

Some embodiments provide technical improvements by way of various techniques disclosed herein for APs and non-AP STAs to determine when to send response-soliciting frames (e.g., RTS, data frames) or non-response-soliciting frames (e.g., CTS-to-self) during EDCA periods. In some embodiments, the AP may classify non-AP STAs into two or more groups (or classes) and/or announce one or more link and transmission parameters (e.g., a number of failed transmissions) that STAs in each group need to use to determine when they may switch to transmitting non-response-soliciting frames. In some embodiments, the AP may announce link and transmission parameters that specify which STAs are eligible to use non-response-soliciting frames (e.g., criteria that must be satisfied before a STA is eligible to transmit non-response-soliciting frames). Various examples of link and transmission parameters include, but are not limited to, for example, transmissions between an APs and/or STAs, signal quality indicators (e.g., STAs with RSSI less than −75 dBm), failed transmission thresholds (e.g., STAs that have at least two failures for contention), and/or switching algorithms (e.g., STAs may switch to sending a non-response-soliciting frame with a 40% probability).

In various embodiments, non-AP STAs may rely on the signal quality received from the AP to determine the number of transmission failures that they need to experience before switching from sending response-soliciting frames to non-response-soliciting frames. In some embodiments, non-AP STAs may rely on the eavesdropped transmissions from other non-AP STAs or the AP (and rely on link and transmission parameters such as the Modulation and Coding Scheme (MCS) used by those STAs) to determine switching from sending response-soliciting frames to non-response-soliciting frames.

As referred to herein, frames may be classified as response-soliciting or non-response-soliciting, depending on whether such frames require an immediate reply from the recipient or not, respectively. Response-soliciting frames, including, but not limited to, ack-soliciting unicast data frames and RTS frames, necessitate a timely response. For example, a unicast data frame sent from a STA to another device requires an ACK frame to confirm successful reception. Similarly, an RTS frame requires a CTS response before the sender proceeds with data transmission. To facilitate quick responses, STAs typically wait a Short Interframe Space (SIFS) before the reply is sent, minimizing the delay in communication.

By comparison, non-response-soliciting frames do not require an immediate acknowledgment or reply. Examples of non-response-soliciting frames include, but are not limited to, broadcast and multicast data frames and CTS frames. Since multiple devices may receive broadcast and multicast frames, it would be inefficient to require an acknowledgment from every recipient. Instead, these frames are transmitted at lower data rates to maximize their reliability.

Some example embodiments described herein provide techniques for broadening the criteria that determine when a STA may switch from sending response-soliciting frames (e.g., RTS, data frame) to sending non-response-soliciting frames (e.g., CTS-to-self frame) by incorporating link and transmission parameters, such as the received signal quality from the STA at the AP, that result in unequitable channel access as described above. Through careful determination of the link and transmission parameters used as switching criteria, some of the techniques disclosed herein provide STAs with fairer channel access probabilities and balances their tail time latency.

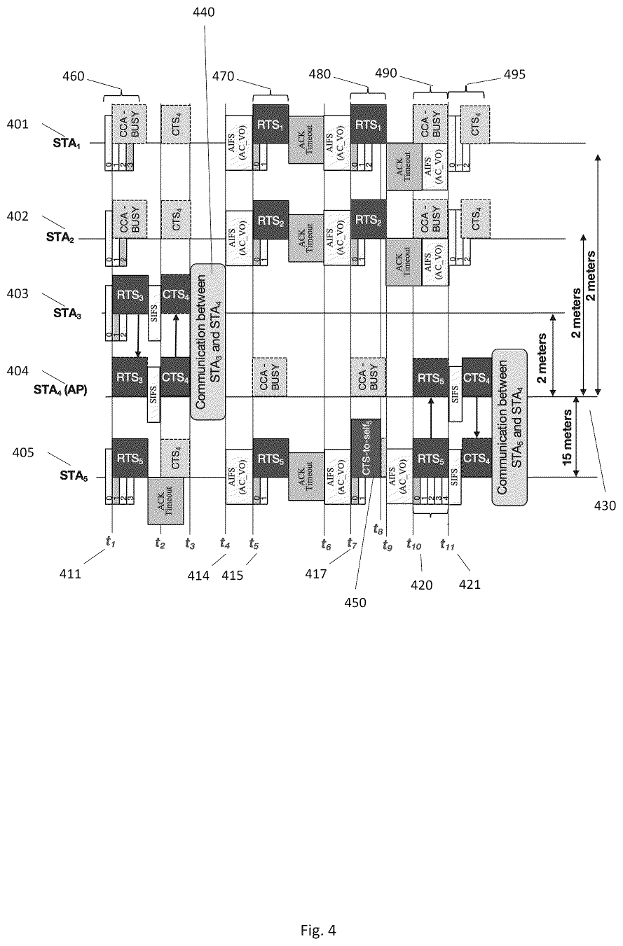

FIG. 4 illustrates an example of transmitting a non-response-soliciting frame in accordance with some example embodiments described herein. In this example, STA 401 (denoted as “STA₁”), STA 402 (denoted as “STA₂”), STA 403 (denoted as “STA₃”), and STA 405 (denoted as “STA₅”) are non-AP STAs that need to send AC_VO traffic (i.e., traffic belonging to the voice access category) to AP 404 (denoted as “STA₄ (AP)”). STA 401, STA 402 and STA 403 are located 2 meters from AP 404, while STA 405 is located 15 meters away from the AP 404, as shown at 430. Accordingly, the RSSI received from STA 401, STA 402, and STA 403 is relatively high (e.g., around −45 dBm) while the RSSI received from STA 405 is relatively low (e.g., around −70 dBm). In the contention round 460, STA 403 and STA 405 both select the one timeslot (denoted by the number “1” in the contention round 460) and transmit RTS frames (denoted as “RTS₃” and “RTS₅” respectively) simultaneously at time 411 (denoted as “t₁”), and initiate their ACK Timeout counters. Since the signal power received from STA 403 is higher, the AP 404 successfully receives the RTS frame sent by STA 403 (e.g., RTS₃). The AP 404 replies to STA 403 with a CTS frame (denoted as “CTS₄”), and both STA 403 and STA 405 receive it. Upon reception of the CTS frame, STA 403 and AP 404 have completed a TXOP reservation and begin communication, as shown at 440. However, since the CTS frame received by STA 405 is not its expected response, STA 405 must wait until the TXOP ends before it can contend for the channel again.

After the TXOP expires at time 414 (denoted as “t₄”), STA 405 waits for AIFS[AC_VO] and then competes for channel access starting at time 415 (denoted as “t₅”). Similarly, STA 401 and STA 402 compete for channel access starting at time 425. During the contention round 470 starting at time 415, STA 401, STA 402, and STA 405 select the same zero timeslot (denoted by the number “0” in the contention round 470) and transmit their frames. However, due to a collision, none of these frames is successfully received by the AP 404.

Using existing techniques, STA 401, STA 402, and STA 405 would wait for ACK Timeout+AIFS[AC_VO] before competing for channel access again. However, using various techniques described herein, STA 405 may switch to sending a non-response-soliciting frame (e.g., CTS-to-self) instead of an RTS frame in the contention round 480, based on a link and transmission parameter such as its received signal quality at the AP 404. During the contention round 480 starting at time 417 (denoted as “t₇”), STA 401, STA 402, and STA 405 select the same zero timeslot (denoted by the number “0” in the contention round 480). STA 401 and STA 402 send RTS frames, while STA 405 sends the CTS-to-self frame, as shown at 450. Due to a collision, the AP 404 does not receive the RTS frames from STA 401 or STA 402 (denoted as “RTS₁” and “RTS₂” respectively). Since the CTS-to-self frame sent by STA 405 is a non-response-soliciting frame, STA 405 starts its next contention round 490 at time 420 (denoted as “t₁₀”), whereas STA 401 and STA 402 cannot start their next contention round 495 until time 421 (denoted as “t₁”). As a result, STA 405 gains priority for channel access. Note that STA 405 may start its contention round 490 about five timeslots before the contention round 495 of STA 401 and STA 402. When STA 405 selects the zero timeslot (denoted by the number “0” in the contention round 490) starting at time 420, its RTS frame does not collide with any other frame. Therefore, with the benefit of various techniques described herein, STA 405 may successfully reserve the TXOP and communicate with the AP 404.

In various embodiment, the link and transmission parameters for switching between response-soliciting and non-response-soliciting frames during the EDCA periods may be determined by non-AP STAs, announced by the AP, negotiated between the AP and non-AP STAs, or combinations thereof. For example, in some embodiments, the AP may assign non-AP STAs to groups and announce link and transmission parameters associated with each group, such as the number of retries needed by the STAs in each group before such STAs are eligible to switch to using non-response-soliciting frames. As an example, there may be two groups of non-AP STAs, where the first group and the second groups are denoted as G₁ and G₂, respectively. In this example, the RSSI received from STAs in G₁ are around −45 dBm and the RSSI received from G₂ are around −65 dBm. Each STA of the two groups needs to send AC_VO data to the AP. Initially, STAs in both groups send RTS or data frames. Since the signal quality received from STAs in G₁ is higher than that of G₂, if a STA in G₁ selects the same timeslot as a STA in G₂, the chance of receiving the frame from the STA in G₁ is higher than that of the STA in G₂, for example, due to the capture effect. Therefore, STAs in G₁ will achieve a lower tail latency compared to STAs in G₂.

Continuing the previous example, some embodiments may resolve this issue for STAs in G₂ by allowing the STAs in G₂ to switch to sending non-response-soliciting frames (e.g., CTS-to-self) instead of RTS (or data) frames based on link and transmission parameters associated with G₂ (e.g., after x retransmission attempts), whereas STAs in G₁ may switch to sending non-response-soliciting frames (e.g., DS frames) instead of RTS (or data) frames based on link and transmission parameters associated with G₁ (e.g., after x+c retransmission attempts, where c>0). In this manner, example embodiments may improve the odds that STAs in G₂ will win channel access if/when they begin to experience too many failed transmissions. Some example embodiments, may further limit the grouping to STAs that have established SCS (Stream Classification Service) agreements with the AP to exchange LL traffic.

In some embodiments, the AP may announce link and transmission parameters, such as, for example, the RSSI distribution of all non-AP STAs. Based on this information, in some embodiments, non-AP STAs may derive the link and transmission parameters for switching to non-response-soliciting frames, such as the number of failed transmissions (e.g., channel access retries) required before switching to non-response-soliciting frames. In various embodiments, when deriving link and transmission parameters, the STAs may also rely on other link and transmission parameters announced by the AP or link and transmission parameters that have been adopted by all the STAs. For example, the AP may have already announced the minimum number of failures that must be experienced before switching.

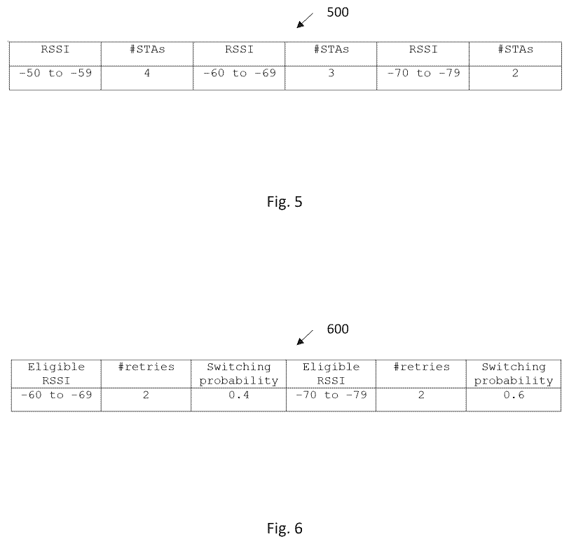

FIG. 5 illustrates an example of link and transmission parameters. For example, the link and transmission parameters 500 may be transmitted by an AP to one or more STAs. As shown, the link and transmission parameters 500 include an RSSI distribution with 4 STAs having an RSSI between −50 dBm to −59 dBm, 3 STAs having an RSSI between −50 dBm to −69 dBm, and 2 STAs having an RSSI between −70 dBm to −79 dBm.

In some embodiments, the AP may announce link and transmission parameters, for example, the RSSI ranges and one or more conditions for when to switch to non-response-soliciting frames based thereon and/or switching algorithms such as probabilities to apply for sending non-response-soliciting frames. For example, FIG. 6 illustrates another example of link and transmission parameters. For example, the link and transmission parameters 600 may be transmitted by an AP to one or more STAs. As shown, the link and transmission parameters 600 allows STAs with RSSI between −60 dBm to −69 dBm to switch to sending non-response-soliciting frames for 40% of contention rounds after experiencing 2 retries, whereas STAs with RSSI between −70 dBm to −79 dBm may switch to sending non-response-soliciting frames for 60% of contentions rounds after experiencing 2 retries. In other examples, link and transmission parameters may include any combination of ranges and/or types of RSSI, failed transmission thresholds, and/or switching algorithms.

In some embodiments, the AP may assign associated non-AP STAs (e.g., based on link and transmission parameters) to one or more groups. For example, the AP may assign STAs to a group by assigning identifiers, labels (e.g., color), or the like to each STA. In an example, the AP may transmit group assignment information that assigns STAs to respective groups. In various embodiments, each group may be associated with link and transmission parameters (e.g., ranges for RSSI, failed transmission thresholds, switching algorithms, etc.). In an example, a STA may receive group assignment information that assigns the STA to a group that is associated with various link and transmission parameters that the STA may use to determine whether to transmit a response-soliciting frame or a non-response-soliciting frame. In some embodiments, the AP may separately announce link and transmission parameters for each group based on network conditions. For example, based on the channel access delay reported by STAs (e.g., through the QoS Characteristics field), the AP may group non-AP STAs by assigning the non-AP STAs into three groups associated to three different identifiers/labels, where the first group corresponds to the least delay and third group corresponds to the longest delay. In such an example, periodically (e.g., in the beacon or other management frame), based on the channel access delay experienced by the STAs in each group, the AP may announce new link and transmission parameters for each group (e.g., for each identifier/label).

In some embodiments, non-AP STAs may decide their own groups (e.g., identifier/label) based on network conditions that it is experiencing (e.g., channel access delay) and/or link and transmission parameters. In an example, the AP may provide group parameter information that may be used by the STAs to determine which group (e.g., identifier/label) the STA may need to use. For example, the STA may assign itself to a group based on group parameter information. In some embodiments, group parameter information may identify various groups and link and transmission parameters associated with each group that may be used by STAs to determine whether to transmit response-soliciting-frames or non-response-soliciting frames.

In some embodiments, each non-AP STA may determine whether to switch from response-soliciting frames to non-response-soliciting frames based on link and transmission parameters including, for example, eavesdropped transmissions of its neighboring STAs. For example, a non-AP STA may infer the distance of other non-AP STAs from the AP based on the MCS of frames exchanged between those non-AP STAs and the AP. In this manner, the STA may use such link and transmission parameters to determine whether to switch from response-soliciting frames to non-response-soliciting frames.

In various embodiments, a STA may use one or more link and transmission parameters in accordance with the embodiments described herein to determine whether to transmit a response-soliciting frame or a non-response-soliciting frame to any other STA or AP. In various embodiments, an AP may use one or more link and transmission parameters in accordance with the embodiments described herein to determine whether to transmit a response-soliciting frame or a non-response-soliciting frame to any other STA or AP.

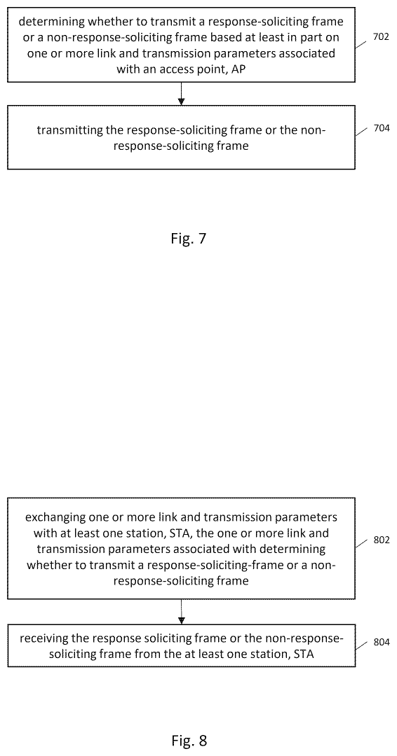

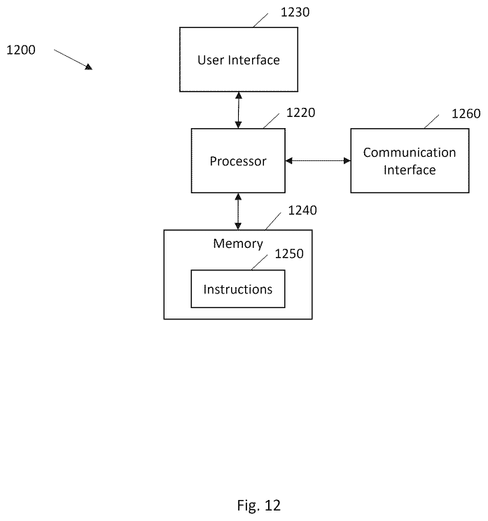

FIGS. 7 and 8 are flowcharts illustrating the operations performed for transmitting and receiving a response-soliciting frame or non-response-soliciting frame in accordance with some of the embodiments disclosed herein. The flowcharts of FIGS. 7 and 8 illustrate the operations performed, such as by the apparatus 1200 of FIG. 12, in order to support communications with one or more other devices (e.g., APs 110, STAs 115).

In the example flowchart of FIG. 7, an apparatus (e.g., STAs 115), which may be embodied such as by apparatus 1200 of FIG. 12, includes means, such as the processor 1220, the communication interface 1260 or the like, for determining whether to transmit a response-soliciting frame or a non-response-soliciting frame based at least in part on one or more link and transmission parameters associated with an access point, AP, as shown in block 702. The determination may be performed by the apparatus 1200 based on operations of the processor 1220 and via communications interface 1260. The apparatus also includes means, such as the processor 1220, the communication interface 1260 or the like, for transmitting the response-soliciting frame or the non-response-soliciting frame, as shown in block 704. Transmitting the response-soliciting frame or the non-response-soliciting frame may be performed by the apparatus 1200 based on operations of the processor 1220 via the communication interface 1260, for example, by transmitting the response-soliciting frame or the non-response-soliciting frame directly or indirectly to another device.

In the example flowchart of FIG. 8, an apparatus (e.g., APs 110), which may be embodied such as by the apparatus 1200 of FIG. 12, includes means, such as the processor 1220, the communication interface 1260 or the like, for exchanging one or more link and transmission parameters with at least one station, STA, the one or more link and transmission parameters associated with determining whether to transmit a response-soliciting-frame or a non-response-soliciting frame, as shown in block 802. The apparatus also includes means, such as the processor 1220, the communication interface 1260 or the like, for receiving the response soliciting frame or the non-response-soliciting frame from the at least one station, STA, as shown in block 804.

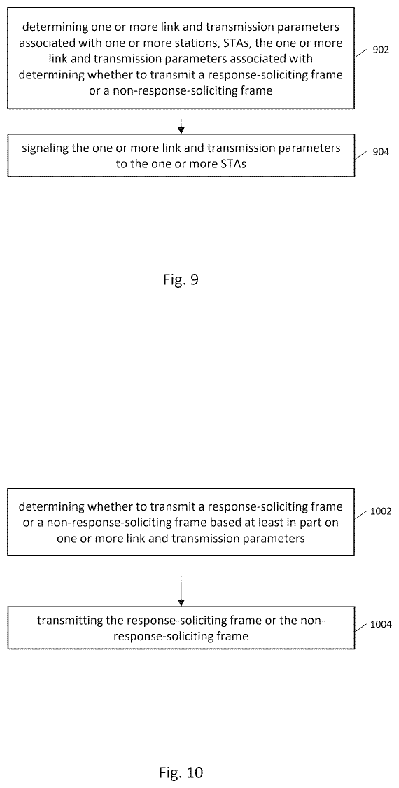

FIGS. 9-11 are flowcharts illustrating the operations performed in association with one or more like and transmission parameters in accordance with some of the embodiments disclosed herein. The flowcharts of FIG. 9-11 illustrate the operations performed, such as by the apparatus 1200 of FIG. 12, in order to support communications with one or more other devices (e.g., APs 110, STAs 115).

In the example flowchart of FIG. 9, an apparatus (e.g., APs 110), embodied, such as by apparatus 1200 of FIG. 12, includes means, such as the processor 1220, the communication interface 1260 or the like, for determining one or more link and transmission parameters associated with one or more stations, STAs, the one or more link and transmission parameters associated with determining whether to transmit a response-soliciting frame or a non-response-soliciting frame, as shown in block 902. The apparatus also includes means, such as the processor 1220, the communication interface 1260 or the like, for signaling the one or more link and transmission parameters to the one or more STAs, as shown in block 904.

In the example flowchart of FIG. 10, an apparatus (e.g., APs 110) which may be embodied by the apparatus 1200 of FIG. 12, includes means, such as the processor 1220, the communication interface 1260 or the like, for determining whether to transmit a response-soliciting frame or a non-response-soliciting frame based at least in part on one or more link and transmission parameters, as shown in block 1002. The apparatus also includes means, such as the processor 1220, the communication interface 1260 or the like, for transmitting the response-soliciting frame or the non-response-soliciting frame, as shown in block 1004. The response-soliciting frame or the non-response-soliciting frame may be transmitted by the apparatus 1200 based on operations of the processor 1220 via the communication interface 1260, for example, by transmitting the response-soliciting frame or the non-response-soliciting frame directly or indirectly to one or more APs or non-AP STAs.

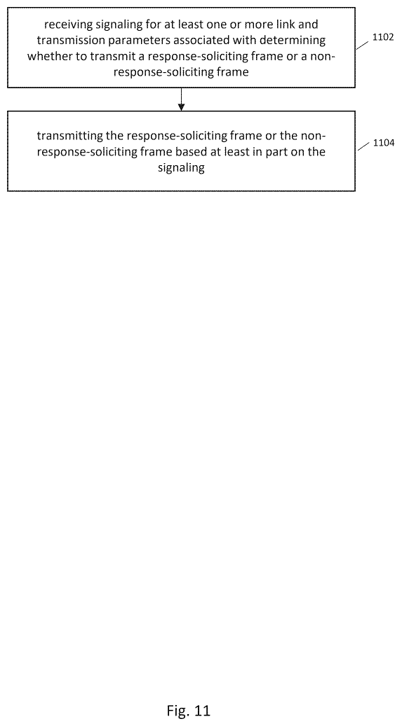

In the example flowchart of FIG. 11, an apparatus (e.g., STAs 115), embodied, such as by apparatus 1200 of FIG. 12, includes means, such as the processor 1220, the communication interface 1260 or the like, for receiving signaling for at least one or more link and transmission parameters associated with determining whether to transmit a response-soliciting frame or a non-response-soliciting frame, as shown in block 1102. The apparatus also includes means, such as the processor 1220, the communication interface 1260 or the like, for transmitting the response-soliciting frame or the non-response-soliciting frame based at least in part on the signaling, as shown in block 1104.

FIGS. 7-11 are flowcharts illustrating methods according to certain example embodiments. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by instructions, such as for example computer program instructions. In this regard, the instructions which embody the procedures described above may be stored by the memory 1240 of an apparatus 1200 employing an example embodiment and executed by at least one processor 1220. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In FIG. 1, client devices 115 are configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, user equipment (UEs), and/or other entities suitable for such usage.

In some examples, the communications system 100 may support radiofrequency sensing during IFS. In some examples, the communications system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The network manager may include a processor and/or a memory (e.g., such as a processor 1220 and/or a memory 1240, further described with respect to FIG. 12). The processor 1220 may be used to execute the instructions 1250 stored in the memory 1240 and/or to store information in the memory 1240, for example, such as the results of the executed instructions.

The Wi-Fi APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver.

An apparatus 1200 may be implemented by a user device to which resources on the access interface are allocated and assigned, and thus any feature described herein with a user device may be implemented with a corresponding apparatus, such as the apparatus 1200. The Wi-Fi AP 110 may further include a processor (e.g., such as the processor 1220) and a memory (e.g., such as the memory 1240), such that the apparatus 1200 may also be embodied by an AP. The processor 1220 may be used to execute the instructions 1250 stored in the memory 1240 and/or to store information in the memory 1240, for example, such as the results of the executed instructions.

The apparatus 1200 may be configured to function as the cloud network 105, APs 110, client devices 115, and/or other entities. As shown in FIG. 12, the apparatus includes, is associated with, and/or is in communication with: a processor 1220, a memory 1240, and a communication interface 1260. The processor 1220 may be in communication with the memory device 1240 via a bus for passing information among components of the apparatus 1200. The memory device 1240 may be non-transitory and may include, for example, one or more volatile and/or non-volatile memories. In other words, for example, the memory device 1240 may be an electronic storage device (e.g., a computer readable storage medium) comprising gates configured to store data (e.g., bits) that may be retrievable by a machine (e.g., a computing device like the processor 1220). The memory device 1240 may be configured to store information, data, content, applications, instructions, or the like for enabling the apparatus to carry out various functions in accordance with an example embodiment of the present disclosure (e.g., the instructions 1250). For example, the memory device 1240 could be configured to buffer input data for processing by the processor 1220. Additionally or alternatively, the memory device 1240 may be configured to store the instructions 1250 for execution by the processor 1220.

The instructions 1250 may be comprised in a computer-readable medium or a non-transitory computer readable medium. A term “non-transitory”, as used herein, is a limitation of the medium itself (e.g., tangible, not a signal) as opposed to a limitation on data storage persistency (e.g., random access memory (RAM) vs. read only memory (ROM)).

FIG. 12 depicts an example of a simplified block diagram of an apparatus according to various embodiments of the present disclosure, whose implementation may differ from what is shown. The connections shown in FIG. 12 are logical connections; the actual physical connections may be different. It is apparent to a person skilled in the art that the system typically comprises also other functions and structures than those shown in FIG. 12.

The apparatus 1200 may, in some embodiments, be embodied in various computing or communication devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single system on a chip (SOC). As such, in some cases, a chip or chipset may constitute means for performing one or more operations for providing the functionalities described herein.

The processor 1220 may be embodied in a number of different ways. For example, the processor 1220 may be implemented by processing circuitry. For example, the processor 1220 may be embodied as one or more of various hardware processing means such as a coprocessor, a microprocessor, a controller, a digital signal processor (DSP), a processing element with or without an accompanying DSP, or various other circuitry including integrated circuits such as, for example, an application specific integrated circuit (ASIC), a field programmable gate array (FPGA), a microcontroller unit (MCU), a hardware accelerator, a special-purpose computer chip, and/or the like. As such, in some embodiments, the processor 1220 may include one or more processing cores configured to perform independently. A multi-core processor may enable multiprocessing within a single physical package. Additionally or alternatively, the processor 1220 may include one or more processors configured in tandem via the bus to enable independent execution of instructions, pipelining and/or multithreading.

In an example embodiment, the processor 1220 may be configured to execute the instructions 1250 stored in the memory device 1240 or otherwise accessible to the processor 1220. Alternatively or additionally, the processor 1220 may be configured to execute hard coded functionality. As such, whether configured by hardware or software methods, or by a combination thereof, the processor 1220 may represent an entity (e.g., physically embodied in circuitry) capable of performing operations according to an embodiment of the present disclosure while configured accordingly. Thus, for example, when the processor 1220 is embodied as an ASIC, FPGA, and/or the like, the processor 1220 may be specifically configured hardware for conducting the operations described herein. Alternatively or additionally, as another example, when the processor 1220 is embodied as an executor of instructions (e.g., instructions 1250), the instructions may specifically configure the processor to perform the algorithms and/or operations described herein when the instructions are executed. However, in some cases, the processor 1220 may be a processor of a specific device (e.g., an image or video processing system) configured to employ an embodiment of the present disclosure by further configuration of the processor by instructions for performing the algorithms and/or operations described herein. The processor 1220 may include, among other things, a clock, an arithmetic logic unit (ALU), and/or logic gates configured to support operation of the processor 1220.

The communication interface 1260 may be a device and/or circuitry embodied in either hardware or a combination of hardware and software that is configured to receive and/or transmit data, including media content in the form of video or image files, one or more audio tracks, and/or the like. In this regard, the communication interface 1260 may include, for example, an antenna (or multiple antennas) and supporting hardware and/or software for enabling communications with a wireless communication network. Additionally or alternatively, the communication interface 1260 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some examples, the apparatus 1200 may be an access point (AP) or a non-AP station (STA) (e.g., such as a client device) usable in a Wi-Fi network operating in accordance with wireless standards (e.g., IEEE 802.11 standards). For example, the apparatus 1200 may be a terminal device, such as the STAs 115 of FIG. 1. As another example, the apparatus 1200 may be included in such a terminal device, for example, as a chipset configured to control the terminal device. As another example, the apparatus 1200 may be a non-AP STA, such as the APs 110 of FIG. 1. The apparatus 1200 may be caused or configured to perform at least the method of FIGS. 9-12 and/or any one or more of the embodiments described.

In an embodiment, at least some of the processes described herein may be carried out by an apparatus comprising means for carrying out at least some of the described processes. Means for performing elements of the method as disclosed herein may include software and/or hardware components of the apparatus 1200. For example, the at least one processor 1220, the memory 1240, and the instruction 1250 form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor and at least one memory storing instructions that, when executed by the at least one processor, cause the apparatus to perform at least:
determining one or more link and transmission parameters associated with one or more stations, STAs, the one or more link and transmission parameters associated with determining whether to transmit a response-soliciting frame or a non-response-soliciting frame; and
signaling the one or more link and transmission parameters to the one or more STAs.

2. The apparatus according to claim 1, wherein the one or more link and transmission parameters are used by the one or more STAs to determine whether to transmit the response-soliciting frame or the non-response-soliciting frame.

3. The apparatus according to claim 1, wherein:
the instructions, when executed by the at least one processor, cause the apparatus to further perform at least assigning at least one of the one or more STAs to a group based on the one or more link and transmission parameters, wherein the group is associated with one or more link and transmission parameters used to determine whether to transmit the response-soliciting frame or the non-response-soliciting frame; and
signaling the one or more link and transmission parameters comprises indicating the group.

4. The apparatus according to claim 1, wherein:
the instructions, when executed by the at least one processor, cause the apparatus to further perform at least determining group parameter information by determining one or more link and transmission parameters associated with each group of one or more groups, the one or more link and transmission parameters of each group being usable to determine whether to transmit a response-soliciting frame or a non-response-soliciting frame; and
signaling the one or more link and transmission parameters comprises indicating the group parameter information.

5. The apparatus according to claim 1, wherein the one or more link and transmission parameters comprise at least one signal quality indicator, the at least one signal quality indicator comprising at least one received signal strength indicator, RSSI.

6. The apparatus according to claim 1, wherein the one or more link and transmission parameters comprise at least one switching algorithm.

7. The apparatus according to claim 6, wherein the at least one switching algorithm comprises a probability used for determining whether to transmit the response-soliciting frame or the non-response-soliciting frame.

8. The apparatus according to claim 1, wherein the one or more link and transmission parameters comprise at least one failed transmissions threshold indicative of a number of failed transmissions necessary to be eligible to transmit the non-response-soliciting frame.

9. The apparatus according to claim 1, wherein the one or more link and transmission parameters are associated with transmissions between the apparatus and the one or more STAs.

10. The apparatus according to claim 1, wherein the instructions, when executed by the at least one processor, cause the apparatus to further perform at least:
receiving a non-response-soliciting frame from a first STA of the one or more STAs; and
receiving a response-soliciting frame from a second STA of the one or more STAs at an overlapping time as the non-response-soliciting frame, wherein the non-response-soliciting frame enables the first STA to compete for channel access sooner as compared to the second STA.

11. A method comprising:
determining one or more link and transmission parameters associated with one or more stations, STAs, the one or more link and transmission parameters associated with determining whether to transmit a response-soliciting frame or a non-response-soliciting frame; and
signaling the one or more link and transmission parameters to the one or more STAs.

12. The method according to claim 11, wherein the one or more link and transmission parameters are used by the one or more STAs to determine whether to transmit the response-soliciting frame or the non-response-soliciting frame.

13. The method according to claim 11, further comprising assigning at least one of the one or more STAs to a group based on the one or more link and transmission parameters, wherein the group is associated with one or more link and transmission parameters used to determine whether to transmit the response-soliciting frame or the non-response-soliciting frame, and wherein signaling the one or more link and transmission parameters comprises indicating the group.

14. The method according to claim 11, further comprising determining group parameter information by determining one or more link and transmission parameters associated with each group of one or more groups, the one or more link and transmission parameters of each group being usable to determine whether to transmit a response-soliciting frame or a non-response-soliciting frame, and wherein signaling the one or more link and transmission parameters comprises indicating the group parameter information.

15. The method according to claim 11, wherein the one or more link and transmission parameters comprise at least one signal quality indicator, the at least one signal quality indicator comprising at least one received signal strength indicator, RSSI.

16. The method according to claim 11, wherein the one or more link and transmission parameters comprise at least one switching algorithm.

17. An apparatus comprising at least one processor and at least one memory storing instructions that, when executed by the at least one processor, cause the apparatus to perform at least:
receiving signaling for at least one or more link and transmission parameters associated with determining whether to transmit a response-soliciting frame or a non-response-soliciting frame; and
transmitting the response-soliciting frame or the non-response-soliciting frame based at least in part on the signaling.

18. An apparatus comprising at least one processor and at least one memory storing instructions that, when executed by the at least one processor, cause the apparatus to perform at least:
determining whether to transmit a response-soliciting frame or a non-response-soliciting frame based at least in part on one or more link and transmission parameters; and
transmitting the response-soliciting frame or the non-response-soliciting frame.

19. The apparatus according to claim 18, wherein the apparatus is an access point, AP.

20. The apparatus according to claim 18, wherein transmitting the response-soliciting frame or the non-response-soliciting frame comprises transmitting the response-soliciting frame or the non-response-soliciting frame to least one of an AP or a non-AP station, STA.
